(19) United States
(12) Patent Application Publication
(10) Pub. No.: US 2022/0339912 A1
(43) Pub. Date: Oct. 27, 2022

(54) COMPOSITE PANEL AND METHOD FOR MANUFACTURING THE SAME

(71) Applicants: HYUNDAI MOTOR COMPANY, Seoul (KR); Kia Corporation, Seoul (KR)

(72) Inventors: Sang-Jae YOON, Yongin-si (KR); YongBeom LEE, Seoul (KR); Sang Beom PARK, Yongin-si (KR); Kyungbin KIM, Busan (KR); Sang Won LIM, Seoul (KR); Chi Hoon CHOI, Suwon-si (KR); Suk Jun CHAI, Sejong-si (KR); SangYoon PARK, Seoul (KR)

(73) Assignees: HYUNDAI MOTOR COMPANY, Seoul (KR); Kia Corporation, Seoul (KR)

(21) Appl. No.: 17/393,853

(22) Filed: Aug. 4, 2021

(30) Foreign Application Priority Data
Apr. 27, 2021 (KR) 10-2021-0054492

(51) Int. Cl. B32B 25/10; B32B 5/02; B32B 25/16; B32B 37/14; B62D 25/06

(52) U.S. Cl. CPC B32B 25/10; B32B 5/024; B32B 25/16; B32B 37/14; B62D 25/06; B32B 2260/046; B32B 2260/021; B32B 2262/106; B32B 2262/101; B32B 2262/0269; B32B 2307/732; B32B 2255/02; B32B 2307/56; B32B 2605/00

(57) ABSTRACT

A composite panel including a vibration suppression layer includes: a rubber material; a first structure material layer positioned on the vibration suppression layer and including a fiber reinforced plastic (FRP); and a second structure material layer positioned under the vibration suppression layer and including a fiber reinforced plastic.

### CROSS-REFERENCE TO RELATED APPLICATION

This application claims priority to and the benefit of Korean Patent Application No. 10-2021-0054492, filed on Apr. 27, 2021, the entire contents of which are incorporated herein by reference.

### FIELD

The present disclosure relates to a composite panel for a vehicle roof and a manufacturing method thereof.

### BACKGROUND

The statements in this section merely provide background information related to the present disclosure and may not constitute prior art.

Fiber Reinforced Plastic (FRP) is lightweight, high-strength, and excellent in corrosion resistance, so it has been attempted to use FRP as an external panel of various transportation devices including vehicles. FRP is applied to external panels such as, for example, a vehicle hood or fender.

There is an attempt to apply the FRP to the roof panel of the vehicle by replacing an existing steel or glass roof for the purpose of a moving a mass center through weight reduction, aesthetics, and marketability by consumer needs.

In this case, it is desired to improve on the negative effects that the plastic material shows, which are different from the vibration characteristics of steel, and which causes psychological discomfort to the driver.

Particularly, in existing technologies, roofs including carbon fiber reinforced plastic (CFRP) composite materials of various concepts have been proposed, but most of them are only aimed at compositions of materials and stackings, or manufacturing methods, etc., and there is no attempt to improve vibration characteristics thereof.

The above information disclosed in this Background section is only for enhancement of understanding of the background of the disclosure, and therefore it may contain information that does not form the prior art that is already known to a person of ordinary skill in the art.

### SUMMARY

One form provides a composite panel with an improved raindrop sound (a sound made when raindrops fall on the car) and vibration characteristics, thereby removing a vibration suppression pad, reducing weight, and reducing cost.

According to one form of the present disclosure, a composite panel including a vibration suppression layer includes: a rubber material; a first structure material layer positioned on the vibration suppression layer and including a fiber reinforced plastic (FRP); and a second structure material layer positioned under the vibration suppression layer and including a fiber reinforced plastic.

The vibration suppression layer may include a resin matrix and a synthetic rubber supported by the resin matrix.

The resin matrix may include an epoxy resin.

The synthetic rubber may include ethylene propylene diene monomer (EPDM) rubber.

The first or second structure material layer may include a unidirectional fabric, and an epoxy resin impregnated into the unidirectional fabric.

The unidirectional fabric may include carbon fiber, glass fiber, aramid fiber, or a combination thereof.

The first or second structure material layer may include a multiaxis non-crimp fabric in which a plurality of unidirectional fabrics is stacked to have a cross angle, and an epoxy resin impregnated into the multiaxis non-crimp fabric.

In the multiaxis non-crimp fabric, the cross angle of the unidirectional fabrics may be greater than 0 degrees and less than 90 degrees.

The thickness of the vibration suppression layer may be 0.1 mm to 0.3 mm.

The thickness of the first structure material layer or the second structure material layer may be 0.36 mm to 0.56 mm.

The thickness ratio of the vibration suppression layer and the first structure material layer or the second structure material layer may be 1:1.2 to 1:5.6.

A surface layer positioned on the first structure material layer, and a surface symmetrical layer positioned under the second structure material layer, may be further included.

The surface layer may include a woven fabric.

A painting layer positioned on the first structure material layer may be further included.

According to another form, a composite panel including a resin fluidized layer includes: a fiber layer; a first vibration suppression layer positioned on the resin fluidized layer and including a rubber material; a second vibration suppression layer positioned under the resin fluidized layer and including a rubber material; a first structure material layer positioned on the first vibration suppression layer and including a fiber-reinforced plastic; and a second structure material layer positioned under the second vibration suppression layer and including a fiber-reinforced plastic.

According to another form, a manufacturing method of a composite panel includes laminating a unidirectional fabric on both surfaces of an unvulcanized ethylene propylene diene monomer (EPDM) rubber; impregnating an epoxy resin to the laminated structure; and curing the epoxy resin while simultaneously vulcanizing the ethylene propylene diene monomer rubber.

According to another form, a manufacturing method of a composite panel includes laminating an unvulcanized ethylene propylene diene monomer (EPDM) rubber on both surfaces of a fiber layer; laminating a unidirectional fabric on both surfaces of the laminated structure; impregnating an epoxy resin into the laminated structure; and curing the epoxy resin while simultaneously vulcanizing the ethylene propylene diene monomer rubber.

The manufacturing method of the composite panel may further include laminating a woven fabric on both surfaces of the laminated structure before impregnating the epoxy resin into the laminated structure.

The manufacturing method of the composite panel may further include forming a painting layer on one surface of the laminated structure after curing the epoxy resin.

The composite panel according to the present disclosure has improved raindrop sound and vibration characteristics, so that a vibration suppression pad may not be included, and a lighter weight and a cost reduction may be obtained.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a partial exploded perspective view showing a state that a composite panel is installed on a vehicle;

FIG. 2 is a cross-sectional view showing an example of a composite panel according to one form of the present disclosure;

FIG. 3 is a cross-sectional view showing another example of a composite panel according to another form of the present disclosure;

FIG. 4 is a cross-sectional view showing another example of a composite panel according to one form of the present disclosure.

FIG. 5 is a cross-sectional view showing a mechanism by which a raindrop sound is attenuated in a composite panel of FIG. 2;

FIG. 6 is a cross-sectional view showing a mechanism by which a vehicle body vibration is attenuated in a composite panel of FIG. 2;

FIG. 7 is a cross-sectional view showing a composite panel manufactured in comparative example 1;

FIG. 8 is a cross-sectional view showing a composite panel manufactured in reference example 1;

FIG. 9 is a diagram showing a stress distribution of each layer according to a load of a composite panel manufactured in comparative example 1, embodiment examples 1 to 3, and reference example 1;

FIG. 10 is a graph showing a vibration emission performance measuring result of a composite panel manufactured in comparative example 1 and embodiment example 1;

FIG. 11 is a graph showing an actual vehicle raindrop sound pressure measurement result of a composite panel manufactured in comparative example 1 and embodiment example 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Advantages and features of the technology to be described later, and a method for achieving them, will become apparent with reference to forms described later in detail together with accompanying drawings. However, implemented forms may not be limited to the forms disclosed below. Although not specifically defined, all terms including technical and scientific terms used herein have meanings understood by ordinary persons skilled in the art. The terms have specific meanings coinciding with related technical references and the present specification as well as lexical meanings. That is, the terms are not construed as having idealized or formal meanings.

In addition, unless explicitly described to the contrary, the word “comprise”, and variations such as “comprises” or “comprising”, will be understood to imply the inclusion of stated elements but not the exclusion of any other elements.

In addition, the terms of a singular form may include plural forms unless referred to the contrary.

In the drawings, the thickness of layers, films, panels, regions, etc., are exaggerated for clarity. Like reference numerals designate like elements throughout the specification.

It will be understood that when an element such as a layer, film, region, or substrate is referred to as being “on” another element, it can be directly on the other element or intervening elements may also be present. In addition, when an element such as a layer, a film, a region, or a substrate is said to be “on” of another element, it also includes a case where the top and bottom are reversed and are “under”.

Likewise, it will be understood that when an element such as a layer, a film, a region, or a substrate is referred to as being “under” another element, it can be directly under the other element or intervening elements may also be present. In addition, when an element such as a layer, a film, a region, or a substrate is said to be “below” another element, it also includes a case where the top and bottom are reversed and are “on”.

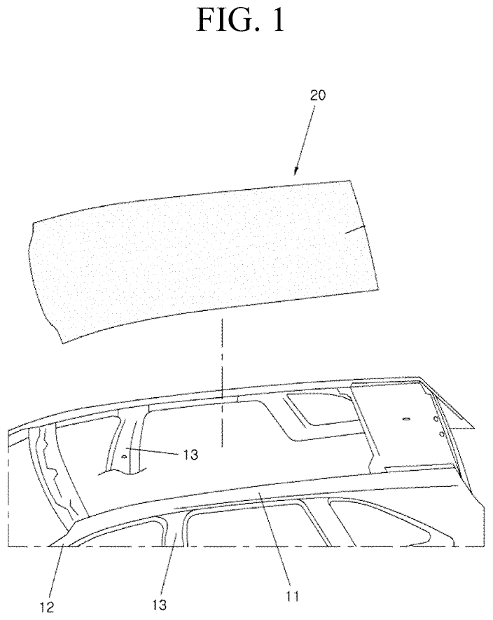

FIG. 1 is a partial exploded perspective view showing a state that a composite panel is installed to a vehicle. FIG. 1 illustrates a case where the composite panel is applied to a roof panel for a vehicle.

Referring to FIG. 1, the vehicle includes a roof rail 11, and an A-pillar 12, and a B-pillar 13 for connecting the roof rail 11 to a vehicle body. The composite panel 20 has a length that extends from the top of the A-pillar 12 to the rear end of the vehicle roof in the vehicle, and has a width between the roof rails 11 spaced apart from each other.

However, the composite panel 20 is not limited to what is shown in FIG. 1, and an assembly shape and a shape thereof may vary. For example, the composite panel 20 may be directly bonded to the vehicle body, or may be mechanically assembled with the vehicle body through a separate bracket. In addition, the composite panel 20 includes cases where the roof has curves for character lines.

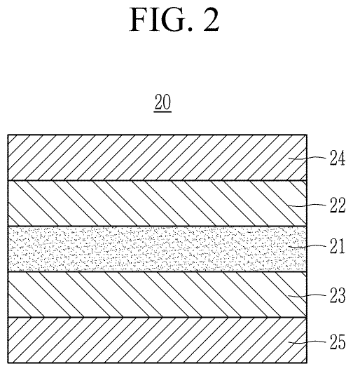

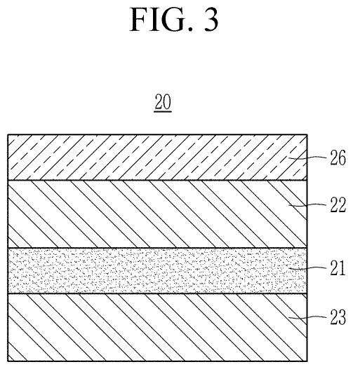

FIG. 2 and FIG. 3 are cross-sectional views showing different examples of a composite panel according to one form of the present disclosure.

Referring to FIG. 2 and FIG. 3, the composite panel 20 includes a vibration suppression layer 21, a first structure material layer 22 positioned on the vibration suppression layer 21, and a second structure material layer 23 positioned under the vibration suppression layer 21.

In other words, the composite panel 20 includes a vibration suppression layer 21 for improving vibration suppression performance between the first structure material layer 22 and the second structure material layer 23 including a fiber reinforced plastic (FRP) to maintain the mechanical performance of the outer plate.

Since the composite panel 20 bonded to the vehicle body is usually exposed to torsional and bending loads, it is supported through the first structure material layer 22 or the second structure material layer 23. Accordingly, the first structure material layer 22 or the second structure material layer 23 may include a fiber reinforced plastic (FRP).

As an example, the fiber reinforced plastic of the first structure material layer 22 or the second structure material layer 23 may include a unidirectional fabric and an epoxy resin impregnated in the unidirectional fabric.

The unidirectional fabric may include carbon fiber, glass fiber, aramid fiber, or a combination thereof.

The type of the epoxy resin is not particularly limited, but examples include a bisphenol-based epoxy resin (a bisphenol A type of epoxy resin, a bisphenol F type of epoxy resin), or an epoxy resin containing a cyanate ester.

As another example, the first structure material layer 22 or the second structure material layer 23 may include a multiaxis non-crimp fabric in which a plurality of unidirectional fabrics is stacked to have cross angles, and an epoxy resin impregnated in the multiaxis non-crimp fabric.

The cross angle between the unidirectional fabrics stacked in the multiaxis non-crimp fabrics may be greater than 0 degrees and less than 90 degrees, for example when being stacked with the cross angle of 45 degrees, it is possible to provide the desired vehicle body strength by reinforcing the torsional strength of the roof.

In addition, in the desired performance related to the first structure material layer 22 or the second structure material layer 23, the bending and torsional properties dominate and take precedence over tensile and compressive properties. Therefore, the first structure material layer 22 and the second structure material layer 23 should be symmetrical with respect to a neutral axis of the vibration suppression layer 21, and since it is possible to inhibit a mechanical performance imbalance, and distortion of a molded product after molding, the first structure material layer 22 and the second structure material layer 23 may have the same thickness.

The composite panel 20 may further include a surface layer 24 positioned on the first structure material layer 22 and a surface symmetrical layer 25 positioned under the second structure material layer 23.

The surface layer 24 may include a woven fabric that is highly favored by consumers because it is aesthetically pleasing as a woven pattern is exposed. The surface layer 24 may have the thickness of 0.2 mm to 0.25 mm.

The surface symmetrical layer 25 is symmetrical with the surface layer 24 in order to inhibit the distortion of the molded product and provide quasi-isotropic mechanical performance, and a size of the fiber bundle does not need to be matched to reduce a cost.

However, as shown in FIG. 3, when further including a painting layer 26 positioned on the first structure material layer 22, since the surface is painted in color, the aesthetics are meaningless, so it is advantageous to not include the surface layer 24 and the surface symmetrical layer 25 in terms of component cost.

The vibration suppression layer 21 includes a rubber material that is advantageous to improve a vibration suppression characteristic. The rubber material should not have any influence on the molding characteristics and the interlayer bonding force of the composite panel 20.

For example, the vibration suppression layer 21 includes a matrix including an epoxy resin and a synthetic rubber supported by the matrix.

The type of the epoxy resin is not particularly limited, but examples include a bisphenol-based epoxy resin (a bisphenol A type of epoxy resin, a bisphenol F type of epoxy resin), or an epoxy resin containing a cyanate ester.

As a synthetic rubber, ethylene propylene diene monomer rubber may be used, which is capable of increasing adherence with the epoxy resin of the matrix of the composite panel 20, has a heat-resistant characteristic to be molded together under high temperature and high pressure in the molding process of the composite panel 20, and has a low specific gravity, durability, and excellent vibration characteristics, such as elasticity and attenuation depending on an amplitude of a vibration.

The vibration suppression layer 21 is manufactured by mixing a rubber with an epoxy resin matrix, thereby increasing the interlayer bonding strength of the rubber-composite material. At this time, it is necessary to not mix too much matrix material to lose the function of the rubber itself, or to mix too little to lose the bonding strength. Accordingly, the vibration suppression layer 21 may include, for the entire weight of the vibration suppression layer 21, the matrix at 7 wt % or less, for example, 6 wt % or less, 5 wt % or less, 4 wt % or less, 3 wt % or less, or 3 wt % to 7 wt %, and the rubber at 93 wt % or more, for example, 94 wt % or more, 95 wt % or more, 96 wt % or more, 97 wt % or more, or 93 wt % to 97 wt %. In addition, if additional functions are desired, a filler that may perform the corresponding function may be further included by adjusting the weight of the rubber.

On the other hand, the vibration suppression layer 21 should not inhibit the interlayer adherence of the composite panel 20. In this case, it may cause insufficient molding quality and cause an imbalance between materials, resulting in interlayer delamination and deteriorated physical properties of the part. The vibration suppression layer 21 should not adversely affect the molding process of the composite panel 20. In the molding process of the composite panel 20, the matrix resin flows according to temperature and pressure conditions and then hardens after forming a shape, since the rubber material may interfere the flow because it is disadvantageous in penetrating the resin. There should be no deformation or separation of the material during the molding of the composite panel 20. Specifically, the material should not melt, flow, or be lost under high temperature and high pressure conditions, and should not deviate from the designated position during the pressurization step due to incorrect position selection.

In addition, if the thickness of the vibration suppression layer 21 is increased, the vibration suppression characteristic improvement may be expected, but since this may be a trade-off relationship with the mechanical performance, thickness and position may be selected based on the desired performance.

For example, when the composite panel 20 is assembled to the vehicle body, it is mainly exposed to torsional and bending environments in driving circumstances, by using the characteristic of reducing the bending and shear loads on the stacked central portion by the same principle as an I-Beam. Therefore, it is advantageous to dispose the vibration suppression layer 21, which has low mechanical properties.

In addition, since the thickness of the vibration suppression layer 21 is inversely proportional to the bending and shear characteristics, the vibration suppression layer is constructed with the thickness that may maintain equivalent physical properties through a physical property calculation. For example, the material properties in the composite panel 20 are shown in Table 1 below.

TABLE 1

| | Tensile | | Tensile elastic | | Shear elastic | |
|---|---|---|---|---|---|---|
| | strength | | coefficient | | coefficient | |
| Surface layer | 698 | MPa | 55 | GPa | 3.6 | GPa |
| Structure | 2172 | MPa | 110 | GPa | 3.8 | GPa |
| material layer | | | | | | |
| Vibration | 10 | MPa | 0.28 | GPa | 0.09 | GPa |
| suppression layer | | | | | | |

In addition, since it is difficult to control the thickness of the woven fabric forming the surface layer 24 compared to the unidirectional fabric of the first structure material layer 22 or the second structure material layer 23 due to the manufacturing characteristic where the fibers are orthogonal, it is easy to control the thickness of the first structure material layer 22 or the second structure material layer 23.

Therefore, by improving the thickness of the vibration suppression layer 21 using classical laminate theory of the composite panel 20, the thickness of the vibration suppression layer 21 may be 0.1 mm to 0.3 mm, for example, 0.11 mm to 0.29 mm, 0.12 mm to 0.28 mm, 0.13 mm to 0.27 mm, 0.14 mm to 0.26 mm, 0.15 mm to 0.25 mm, 0.16 mm to 0.24 mm, 0.17 mm to 0.23 mm, 0.18 mm to 0.22 mm, 0.19 mm to 0.21 mm, or 0.20 mm.

The thickness of the first structure material layer 22 or the second structure material layer 23 may be 0.36 mm to 0.56 mm, for example, 0.38 mm to 0.54 mm, 0.40 mm to 0.52 mm, 0.42 mm to 0.50 mm, or 0.44 mm to 0.48 mm.

In addition, the thickness ratio of the vibration suppression layer 21 and the first structure material layer 22 or the second structure material layer 23 may be 1:1.2 to 1:5.6, for example, 1:1.4 or more, 1:1.6 or more, or 1:1.8 or more, and may be 1:5 or less, 1:4 or less, or 1:3.6 or less.

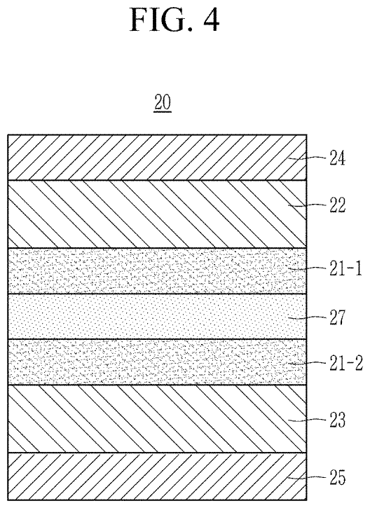

FIG. 4 is a cross-sectional view showing another example of a composite panel according to one form of the present disclosure.

Referring to FIG. 4, the composite panel 20 may include a resin fluidized layer 27 including a fiber layer, a first vibration suppression layer 21-1 positioned on the resin fluidized layer 27 and including a rubber material, a second vibration suppression layer 21-2 positioned under the resin fluidized layer 27 and including a rubber material, a first structure material layer 22 positioned on the first vibration suppression layer 21-1 and including a fiber reinforced plastic, and a second structure material layer 23 positioned under the second vibration suppression layer 21-2 and including a fiber reinforced plastic.

In this case, the thickness of the first vibration suppression layer 21-1 to second vibration suppression layer 21-2 may be 0.01 mm to 0.1 mm, for example, 0.05 mm to 0.1 mm, 0.05 mm to 0.09 mm, or 0.06 mm to 0.08 mm.

The composite panel 20, as shown in FIG. 4, may further include a surface layer 24 positioned on the first structure material layer 22 and a surface symmetrical layer 25 positioned under the second structure material layer 23, or may further include a painting layer 26 positioned on the first structure material layer 22 without the surface layer 24 and the surface symmetrical layer 25.

In the case of manufacturing the composite panel 20 through an RTM molding method, since the resin may be blocked by the vibration suppression layer 21 and cannot flow into a dry fabric, by dividing the vibration suppression layer 21 into two layers and including the resin fluidized layer 27 including the resin therebetween, it is possible to provide the resin that is impregnated evenly.

For example, the resin fluidized layer 27 may be formed of any fiber material having higher strength than the epoxy resin, and may include, for example, a fiber layer made of a glass fiber material. In addition, it is possible to improve the effect of a weight reduction by including a hollow glass fiber. Since the resin fluidized layer 27 includes the fiber layer made of the glass fiber material, the impregnation of the epoxy resin is improved and the cost may be reduced.

The resin fluidized layer 27 has a fiber volume ratio of 5% to 20%, and its thickness may be ⅕ to ⅓ of the entire thickness of the composite panel 20. If the fiber volume ratio of the resin fluidized layer 27 is less than 5% or the thickness is less than ⅕, the torsional strength and a strength drop of the composite panel 20 may be too large, and if the fiber volume ratio is more than 20% or the thickness is more than ⅓, the effect of the impregnation and the cost reduction that may be obtained when using the glass fiber may be insignificant.

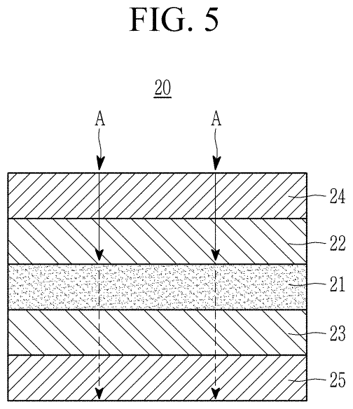

FIG. 5 is a cross-sectional view showing a mechanism by which a raindrop sound is attenuated in a composite panel of FIG. 2.

Referring to FIG. 5, the vibration suppression layer 21 attenuates the vibration A of raindrops falling on the surface of the composite panel 20, thereby reducing an audible noise for passengers inside the vehicle.

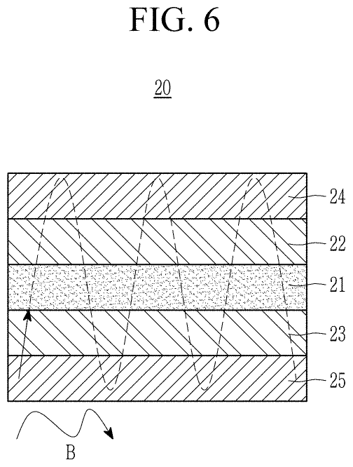

FIG. 6 is a cross-sectional view showing a mechanism by which a vehicle body vibration is attenuated in a composite panel of FIG. 2.

Referring to FIG. 6, when a vibration B of various causes generated during driving is transmitted to the composite panel 20 through the vehicle body, the noise emitted through the composite panel 20 is attenuated by the vibration suppression layer 21, thereby reducing the audible noise to the vehicle occupants.

The manufacturing method of the composite panel 20 according to another form includes stacking (or laminating) a unidirectional fabric on both surfaces of an unvulcanized ethylene propylene diene monomer (EPDM) rubber, and impregnating an epoxy resin into the stacked structure and curing the epoxy resin while simultaneously vulcanizing the ethylene propylene diene monomer rubber.

That is, the rubber of the vibration suppression layer 21 is stacked (laminated) with the fiber structure in the unvulcanized state, and then cured together with the matrix in the molding process of the composite panel 20. Through this, it is possible to increase the interlayer adhesion between the vibration suppression layer 21 of the rubber material and the first structure material layer 22 or the second structure material layer 23.

The epoxy resin may have a viscosity of 50 cps to 200 cps. If the viscosity of the epoxy resin is less than 50 cps, the fluidity is excessively high and the moldability may be deteriorated. If the viscosity is more than 200 cps, the impregnation property may be deteriorated in a short time.

The curing of the epoxy resin may be accomplished by heating to 100° C. to 120° C.

The method of forming the composite panel 20 may use methods such as autoclaving, prepreg compression, or molding, but the method of forming the composite panel 20 in the present disclosure is not limited.

Meanwhile, the manufacturing method of the composite panel 20 may use a resin transfer molding (RTM) method. The RTM molding is a method that creates a pressure difference in the mold and moves the epoxy resin to a place where the pressure is low so that it passes through the laminated structure.

In the case of manufacturing the composite panel 20 through the RTM molding method, the manufacturing method of the composite panel 20 may include laminating the unvulcanized ethylene propylene diene monomer (EPDM) rubber on both surfaces of the fiber layer, laminating the unidirectional fabric on both surfaces of the laminated structure, impregnating the epoxy resin into the laminated structure, and curing the epoxy resin and simultaneously vulcanizing the ethylene propylene diene monomer rubber.

That is, in the case of manufacturing the composite panel 20 through the RTM molding method, since the resin may be blocked by the vibration suppression layer 21 and not flow into the dry fabric, the vibration suppression layer 21 is divided into two layers, and the resin fluidized layer 27 including the fiber layer of the low specific gravity is included, thereby impregnating the resin evenly.

Optionally, the manufacturing method of the composite panel 20 may further include stacking the fabric on both surfaces of the laminated structure, prior to impregnating the epoxy resin into the laminated structure, to form the surface layer 24 and the surface symmetrical layer 25. Alternatively, the manufacturing method of the composite panel 20 may further include forming the painting layer 26 on one surface of the laminated structure after curing the epoxy resin, to form the painting layer 26.

Hereinafter, specific embodiment examples of the disclosure are presented. However, the embodiment examples described below are only intended to specifically illustrate or describe the disclosure, and the scope of the disclosure is not limited thereto.

Manufacturing Example: Manufacturing of a Composite Panel

### Embodiment Example 1

The composite panel 20 was manufactured with the structure shown in FIG. 2.

At this time, the thickness of the vibration suppression layer 21 was 0.2 mm, the thickness of the first structure material layer 22 and the second structure material layer 23 were 0.46 mm, respectively, and the thickness of the surface layer 24 and the surface symmetrical layer 25 were 0.24 mm, respectively.

### Embodiment Example 2

As in embodiment example 1, the composite panel 20 was manufactured with the structure shown in FIG. 2.

However, the thickness of the vibration suppression layer 21 was changed to 0.1 mm, the thickness of the first structure material layer 22 and the second structure material layer 23 were changed to 0.52 mm, respectively, and the thickness of the surface layer 24 and the surface symmetrical layer 25 were changed to 0.24 mm, respectively.

### Embodiment Example 3

As in embodiment example 1, the composite panel 20 was manufactured with the structure shown in FIG. 2.

However, the thickness of the vibration suppression layer 21 was changed to 0.3 mm, the thickness of the first structure material layer 22 and the second structure material layer 23 were respectively changed 0.41 mm, and the thickness of the surface layer 24 and the surface symmetrical layer 25 were changed, respectively, to 0.24 mm.

### Comparative Example 1

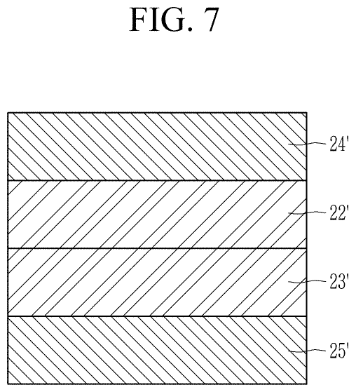

The composite panel 20 was manufactured with the structure shown in FIG. 7.

Referring to FIG. 7, the composite panel 20 of comparative example 1 did not include the vibration suppression layer 21, the first structure material layer 22′ is positioned directly on the second structure material layer 23′, the surface layer 24′ is positioned on the first structure material layer 22′, and the surface symmetrical layer 25′ is positioned under the second structure material layer 23′.

At this time, the thickness of the first structure material layer 22′ and the second structure material layer 23′ was 0.56 mm, respectively, and the thickness of the surface layer 24 and the surface symmetrical layer 25 was 0.24 mm, respectively.

### Reference Example 1

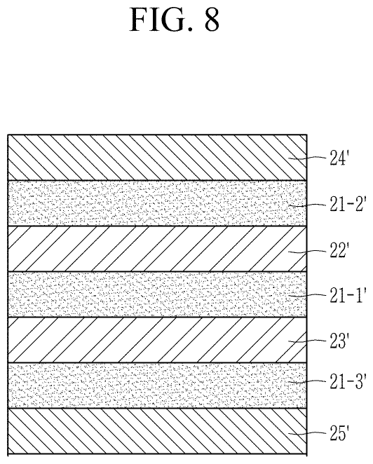

The composite panel 20 was manufactured with the structure shown in FIG. 8.

Referring to FIG. 8, in the composite panel 20 of the reference example 1, the first structure material layer 22′ is positioned on the first vibration suppression layer 21-1′, the second vibration suppression layer 21-2′ is positioned on the first structure material layer 22′, the surface layer 24′ is positioned on the second vibration suppression layer 21-2′, the second structure material layer 23′ is positioned under the first vibration suppression layer (21-1′), the third vibration suppression layer 21-3′ is positioned under the second structure material layer 23′, and the surface symmetrical layer 25′ is positioned under the third vibration suppression layer (21-3′).

At this time, the thickness of the first vibration suppression layer 21-1′ to the third vibration suppression layer 21-3′ is 0.07 mm, respectively, the thickness of the first structure material layer 22′ and the second structure material layer 23′ is 0.46 mm, respectively, and the thickness of the surface layer 24′ and the surface symmetrical layer 25′ is 0.24 mm, respectively.

### Experimental Example 1: Confirming Mechanical Performance of a Composite Panel

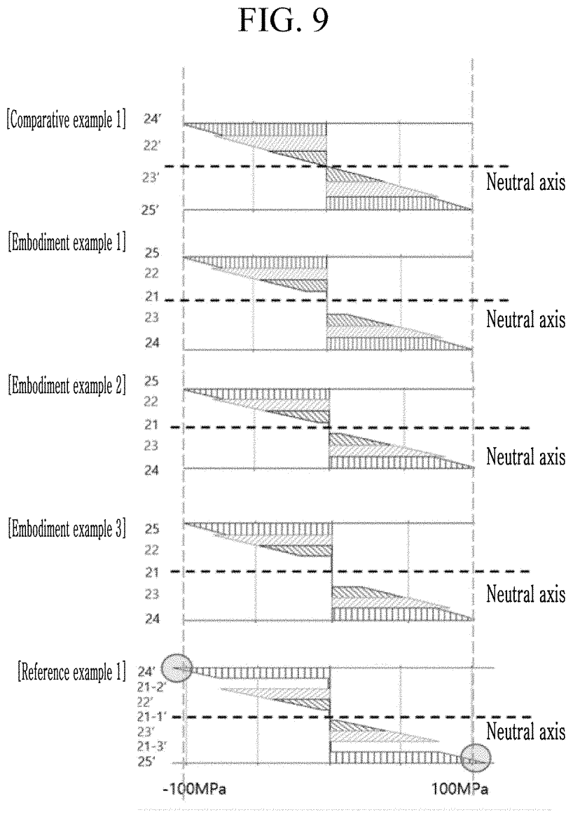

For the composite panel manufactured in the embodiment examples 1 to 3, comparative example 1, and reference example 1, the stress distribution for each layer was calculated under the same thickness (1.6 mm) condition in order to check the validity of the stacked structure, and the result is shown in FIG. 9.

Referring to FIG. 9, in the case of comparative example 1, it may be confirmed that the applied stress is generally low around the neutral axis according to the I-beam effect.

In embodiment examples 1 to 3, it may be confirmed that almost no stress is distributed in the vibration suppression layer, which has weak physical properties. In addition, in the case of embodiment examples 1 to 3, since the structure material layer shares and supports the stress that is not supported at the neutral axis at ±45 degrees, and the value was low, and there was no significant difference in stress compared to the case of comparative example 1, so similar displacement due to the load is expected.

In the case of reference example 1, the distributed vibration suppression layer does not support the increased stress as it moves away from the neutral axis, so the stress burden applied to the surface layer increases, and in terms of physical properties, a higher stress acts on the surface layer, which is unfavorable compared to the structure material layer, thereby an increase of a strain rate causes an increase in the amount of displacement of the part.

In addition, in order to compare unit strength of the composite panel manufactured in embodiment examples 1 to 3, comparative example 1, and reference example 1, the displacement was compared under the same bending/torsional load conditions, and the results are shown in Table 2 below.

TABLE 2

| Load | Comparative | | Embodiment | | Embodiment | | Embodiment | | Reference | |
|---|---|---|---|---|---|---|---|---|---|---|
| condition | Example 1 | | example 1 | | example 2 | | example 3 | | example 1 | |
| Bending | 3.6 | mm | 3.6 | mm | 3.6 | mm | 3.6 | mm | 3.8 | mm |
| Torsional | 2.5 | mm | 2.5 | mm | 2.5 | mm | 2.5 | mm | 2.8 | mm |
| Tensile | 30.88 | GPa | 28.84 | GPa | 29.87 | GPa | 27.66 | GPa | 28.82 | GPa |
| elasticity | | | | | | | | | | |

Referring to Table 2, it may be confirmed that in the case of the embodiment examples 1 to 3, even though the vibration suppression layer, whose physical properties are weak due to the I-beam effect, is included in the central portion, the displacement that is equivalent to that of comparative example 1 appears.

In consideration of the cost and weight reduction, embodiment example 3 is the most advantageous, but since the tensile property value is disadvantageous, it is desirable to select according to the desired performance of the part against the front/side load.

Reference example 1 is relatively unfavorable in terms of the physical properties, but as the number of the vibration suppression layers increases, the vibration suppression characteristic/collision characteristic/life increases, so it is desirable to select according to the desired performance of the part.

### Experimental Example 2: Checking Vibration Emission Performance of a Composite Panel

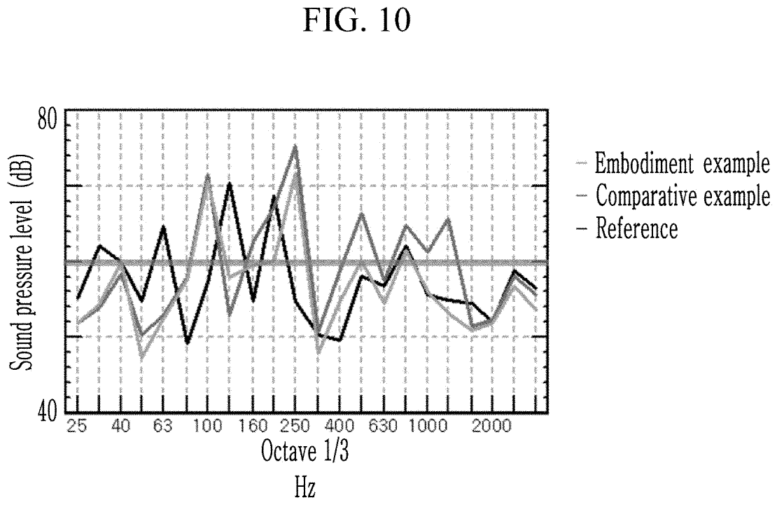

FIG. 10 is a graph showing a vibration emission performance measuring result of a composite panel manufactured in comparative example 1 and embodiment example 1. In FIG. 10, Reference indicates a steel material used.

Referring to FIG. 10, as a result of manufacturing a flat plate of 1000 m² by using the composite panel manufactured in comparative example 1 and embodiment example 1 and the steel material used in mass-produced vehicles and evaluating it with a vibration device consisting of a microphone and a speaker, embodiment example 1 including the vibration suppression layer compared to the stacked structure of comparative example 1, as a sound pressure level was lowered in most of the 25 Hz to 2500 Hz frequency range, exhibited an emission characteristic that was improved to be comparable to that of the steel material.

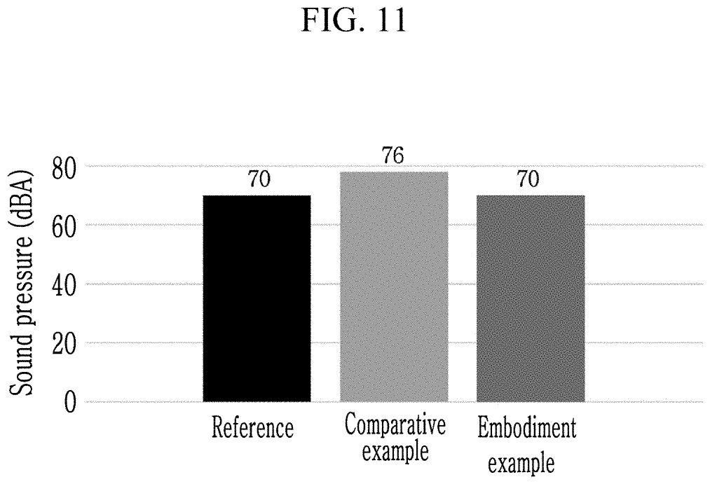

FIG. 11 is a graph showing an actual vehicle raindrop sound pressure measurement result of a composite panel manufactured in comparative example 1 and embodiment example 1. In FIG. 11, Reference denotes a steel material.

Referring to FIG. 11, as a result manufacturing a flat plate of 1000 m² by using the composite panel manufactured in comparative example 1 and embodiment example 1 and the steel material used in mass-produced vehicles and measuring a sound pressure of the raindrop sound at a rear seat by applying it to an actual vehicle, comparative example 1 is inferior to the steel material, but in the case of embodiment example 1, the same level as that of the steel material was obtained.

While this disclosure has been described in connection with what is presently considered to be practical examples, it is to be understood that the disclosure is not limited to the disclosed forms. On the contrary, it is intended to cover various modifications and equivalent arrangements included within the spirit and scope of the present disclosure.

### DESCRIPTION OF SYMBOLS

11: roof rail
12: A pillar
13: B pillar
20: composite panel
21, 21′: vibration suppression layer
21-1, 21-2: first and second vibration suppression layer
21-1′, 21-2′, 21-3′: first to third vibration suppression layer
22, 22′: first structure material layer
23, 23′: second structure material layer
24, 24′: surface layer
25, 25′: surface symmetrical layer
26: painting layer
27: resin fluidized layer

1. A composite panel comprising:
a vibration suppression layer including a rubber material;
a first structure material layer positioned on the vibration suppression layer and including a fiber reinforced plastic (FRP); and
a second structure material layer positioned under the vibration suppression layer and including the fiber reinforced plastic.

2. The composite panel of claim 1, wherein the vibration suppression layer includes a resin matrix and a synthetic rubber supported by the resin matrix.

3. The composite panel of claim 2, wherein:
the resin matrix includes an epoxy resin, and
the synthetic rubber includes ethylene propylene diene monomer (EPDM) rubber.

4. The composite panel of claim 1, wherein the first structure material layer or the second structure material layer includes a unidirectional fabric and an epoxy resin impregnated into the unidirectional fabric.

5. The composite panel of claim 4, wherein the unidirectional fabric includes carbon fiber, glass fiber, aramid fiber, or a combination thereof.

6. The composite panel of claim 1, wherein the first structure material layer or the second structure material layer includes: a multiaxis non-crimp fabric including a plurality of unidirectional fabrics stacked to have a cross angle, and an epoxy resin impregnated into the multiaxis non-crimp fabric.

7. The composite panel of claim 6, wherein a cross angle of the plurality of unidirectional fabrics is greater than 0 degrees and less than 90 degrees.

8. The composite panel of claim 1, wherein a thickness of the vibration suppression layer is 0.1 mm to 0.3 mm.

9. The composite panel of claim 1, wherein a thickness of the first structure material layer or the second structure material layer is 0.36 mm to 0.56 mm.

10. The composite panel of claim 1, wherein a thickness ratio of the vibration suppression layer and the first structure material layer or the second structure material layer is 1:1.2 to 1:5.6.

11. The composite panel of claim 1, further comprising:
a surface layer positioned on the first structure material layer; and
a surface symmetrical layer positioned under the second structure material layer.

12. The composite panel of claim 11, wherein the surface layer includes a woven fabric.

13. The composite panel of claim 1, further comprising a painting layer positioned on the first structure material layer.

14. A composite panel comprising:
a resin fluidized layer including a fiber layer;
a first vibration suppression layer positioned on the resin fluidized layer and including a rubber material;
a second vibration suppression layer positioned under the resin fluidized layer and including a rubber material;
a first structure material layer positioned on the first vibration suppression layer and including a fiber-reinforced plastic; and
a second structure material layer positioned under the second vibration suppression layer and including the fiber-reinforced plastic.

15. A manufacturing method of a composite panel, the manufacturing method comprising:
laminating a unidirectional fabric on a first surface and a second surface of an unvulcanized ethylene propylene diene monomer (EPDM) rubber and forming a laminated structure;
impregnating an epoxy resin into the laminated structure; and
curing the epoxy resin while simultaneously vulcanizing the ethylene propylene diene monomer rubber.

16. A manufacturing method of a composite panel, the manufacturing method comprising:
laminating an unvulcanized ethylene propylene diene monomer (EPDM) rubber on a first surface and a second surface of a fiber layer and forming a first laminated structure;
laminating a unidirectional fabric on a first surface and a second surface of the first laminated structure and forming a second laminated structure;
impregnating an epoxy resin into the second laminated structure; and
curing the epoxy resin while simultaneously vulcanizing the ethylene propylene diene monomer rubber.

17. The manufacturing method of claim 15 or claim 16 further comprising, before impregnating the epoxy resin to the second laminated structure, laminating a woven fabric on a first surface and a second surface of the second laminated structure.

18. The manufacturing method of claim 15 or claim 16, further comprising, after curing the epoxy resin forming a painting layer on a first surface of the second laminated structure.
